(19) United States
(12) Patent Application Publication
(10) Pub. No.: US 2012/0194791 A1
(43) Pub. Date: Aug. 2, 2012

(54) DEVICE AND METHOD FOR PROCESSING PRINTING SUBSTRATE WEB INTO PRINTED PRODUCTS

(75) Inventors: Hanspeter Duss, Buchs (CH); Christoph Gysin, Ormalingen (CH); Markus Bracher, Pfaffnau (CH)

(73) Assignee: Mueller Martini Holding AG, Hergiswil (CH)

(21) Appl. No.: 13/361,200

(22) Filed: Jan. 30, 2012

(30) Foreign Application Priority Data
Jan. 28, 2011 (CH) 00157/11

(51) Int. Cl. G03B 27/42

(52) U.S. Cl. 355/53; 355/77

(57) ABSTRACT

A method for processing a web to form printed products includes affixing a print mark assigned to a printed sheet of the web to a useful strip of the web. The print mark includes a coded print mark. An image is recorded that shows a region of the web in which the affixed print mark is located. The print mark in recorded image is searched for and identified. A position of the print mark in the recorded image is determined, and based on the determined position, the position of the print mark on the web is inferred. A correction value is determined for synchronizing a subsequent further processing of the web in dependence on the position of the print mark on the web.

### CROSS-REFERENCE TO RELATED APPLICATION

This application claims the priority of the Swiss Patent Application No. 00157/11, filed on Jan. 28, 2011, the subject matter of which is incorporated herein by reference.

### BACKGROUND OF THE INVENTION

The invention relates to a method for processing a web composed of a printing substrate to form printed products, as well as to a device for realizing the method.

When using rotary or web-fed printing presses operating with an offset or gravure printing process, as well as high-capacity digital printing presses, the printing operation starts when the web leaves the reel. Following the printing operation, the web must then be cut into sections and, if applicable, folded into signatures. The web generally travels a longer distance between the location of printing and the processing devices used for cutting and folding the printed sheets or signatures. In the process, the print image must be aligned so as to be synchronized with the crosscutter and the folding device to ensure that the printed sheets are cut and/or folded correctly. Print marks are therefore printed onto relevant locations and are subsequently identified with the aid of identification systems. Print marks, in most cases a line, are symbols applied in addition to the printed image and indicate with their position on the printing substrate where a following process is to take place, e.g. a folding and/or cutting process. For this purpose, optical reading units are used to enter the print mark information into the respective further processing devices. The print marks for the different further processing operations can vary. For example, different print marks are widely known for the cutting and folding operations. Accordingly, these print marks are also referred to as cutting marks and/or folding marks. The known detection methods presuppose that the print marks are affixed to a clear or unprinted space, meaning that a useful strip along the web contains only print marks or that at least no other type of printing can be found in the area surrounding the print marks.

Additional, related measuring and control problems come up in connection with the print marks, which problems are nowadays solved with the aid of additional, special sensors. In particular for digital printing, starting at the reel, the sheet must still be identified after being printed onto the web since the individual, different sheets must be combined into printed products after passing through the cross cutter. In the process, it is absolutely necessary that the first sheet of a printed product, which can be composed of several individual pages, can be identified reliably The web can furthermore shift toward the side, meaning the lateral position of the web must also be detected, which is achieved with additional sensors. With known methods for printing multiple sections, which are arranged side-by-side on the web, the printed-on web is also cut into several individual web sections in the transporting direction. It is thus advantageous if the position of the cutting device can also be re-adjusted.

Print marks and especially cutting marks nowadays are usually affixed so that in the transport direction of the web, a strip having a width of at least several mm is left unprinted and only the print marks, in particular the cutting marks, are printed onto this strip. A fast photocell sensor detects practically without time delay a line or another easy symbol used as a print mark and generates a signal with only a few micro-seconds delay, which signal can then be processed by a servo control unit of the cross cutter. The servo control unit can subsequently determine the deviation on the basis of the known, theoretically desired position and the effectively measured actual position and can thus make the correction. However, leaving an unprinted strip on the web for affixing the print marks results in additional cutting or trimming expenditure and produces more waste.

The German patent document DE 102008059584 A1 describes in detail how print units can be synchronized with the aid of print marks. In particular, this document describes that print marks can be composed not only of lines, but can also be complex print symbols. Furthermore described is that matrix cameras can be used in place of the generally used light scanners. The problem of synchronizing print units basically is the same as the problem of synchronizing the downstream-arranged further processing devices, up to the cross cutter for the printed web. The disadvantage of these methods is that they can be used only if the print marks are in a clear space, meaning no other print exists in the area immediately surrounding the marks, at least not in movement direction of the printed web. Light scanners such as matrix cameras which read in the print marks generally used nowadays cannot reliably distinguish between the print marks and the remaining print. With a so-called window technique, an attempt can be made to activate the light scanner or the camera only during a known, short time window in which the print mark must pass below the light scanner and/or the camera. However, the unprinted region between two sheets must be large enough, so that the variation in the transport distance is smaller than the unprinted region containing the print marks, wherein this generally again results in a lot of cutting and trimming and thus a costly paper loss.

Methods are furthermore known, such as those used with print units in web-fed presses, which control the precise printing position of the various color print units. Print images recorded at the approximately known position on the printing substrate are analyzed with the aid of high-resolution digital cameras, thus making it possible to determine the position of the various print images, relative to each other. Print marks could in principle be omitted with a method of this type and the location where a folding a cutting should take place could be determined with the aid of the images recorded of the printed sheets, as well as with the analysis of the images. However, these methods are expensive and furthermore difficult to realize in the downstream processing regions, in particular with the digital printing where the content printed onto the sheets changes constantly.

A method and a device are also known from the European Patent Application EP 2062738 for which a code is printed onto a separate strip of the paper web, which code is then read in by a further processing device. The code contains information that allows making adjustments to the further processing devices by searching for and reading in these codes. However, the code printing location does not directly relate to the code function, meaning that if a code is printed with an offset of only a few millimeters it cannot be used by the further processing devices which read and interpret the code.

### SUMMARY OF THE INVENTION

It is therefore an object of the invention to provide a method and a device for processing a printing web which method and device permit early in the process to configure the synchronizing of the printing web with the a further processing operations, in order to be more cost-effective and flexible.

The above and other objects are accomplished according to the invention by the provision of a method for processing a printing web to form printed products, comprising: a) affixing at least one print mark assigned to a printed sheet of the web to a useful strip of the web, wherein the print mark includes a coded print mark; b) recording at least one image which shows a region of the web in which the at least one affixed print mark is located; c) searching for and identifying the at least one print mark in the at least one recorded image; d) determining a position of the print mark in the at least one recorded image and, based on the determined position, inferring the position of the print mark on the web; and e) determining at least one correction value for synchronizing a subsequent further processing of the web in dependence on the position of the print mark on the web.

In contrast to conventional print marks known from the prior art, which only indicate the position of the required processing steps, the coded print marks contain references to the positioning of the conventional print marks and/or contain information that is needed for the further processing operation, such as the thickness of the printed material, the number for the printed sheet or signature, as well as the format or the type of printed product.

According to another aspect of the invention there is provided a device for processing a printing web to form printed products, the device, in one embodiment, comprising: an image-recording system adapted to be focused onto a printed side of a web for recording an image of a region of the web in which there is located at least one coded print mark including a coded print mark; an image-processing system coupled to receive an output from the image-recording system to evaluate the at least one image, including: searching for and identifying the at least one print mark in the at least one recorded image; determining a position of the print mark in the at least one recorded image and, based on the determined position, inferring the position of the print mark on the web; and determining at least one correction value for synchronizing a subsequent further processing of the web in dependence on the position of the print mark on the web; and a control unit operative to control the image-recording system and the image-processing system.

One advantage of the method and the device according to the invention is that an unprinted strip in the transporting direction of the web is not required since the print marks can be printed onto the useful strip of the web. As a result of using coded print marks, it is furthermore possible to identify a web region that is currently located in a further processing device. On the one hand, these advantages lead to a savings of printing web which reduces the production costs while, on the other hand, they also result in a more flexible processing since the coding of the print marks makes it possible to determine position information for the web and/or the sheets printed onto the web. The subsequent processing steps can thus be adapted easier to the momentary requirements of the further processing device. The flexibility is important, in particular for the digital printing, because constantly changing formats of the printing web must be processed and the editions can become small enough to comprise only one copy.

It is preferable if a stationary reference element, which comprises machine-readable markings, is provided for the device according to the invention. The reference element expands the flexibility of the device according to the invention by helping generate correction values for synchronizing the web with the following processing operation, as described in further detail below.

### BRIEF DESCRIPTION OF THE DRAWINGS

These and other features of the invention will be further understood from the following detailed description with reference to the accompanying drawings, which show in:

FIG. 1 A view from the side of one embodiment of a system for further print processing according to the invention.

FIG. 2 shows a stationary reference element according to further feature of the invention.

FIG. 3 shows a view from above of the web for the system according to FIG. 1, showing a first situation with a print mark within the viewing field of the image detection system.

FIG. 4 shows a view from above of the web for the system according to FIG. 1, showing a second situation where a print mark is not located within the viewing field of the image detection system.

FIG. 5 is an enlarged view of a recorded image according to FIG. 3.

### DETAILED DESCRIPTION

In the Figures, the same reference numbers denote components which operate the same way or have the same effect.

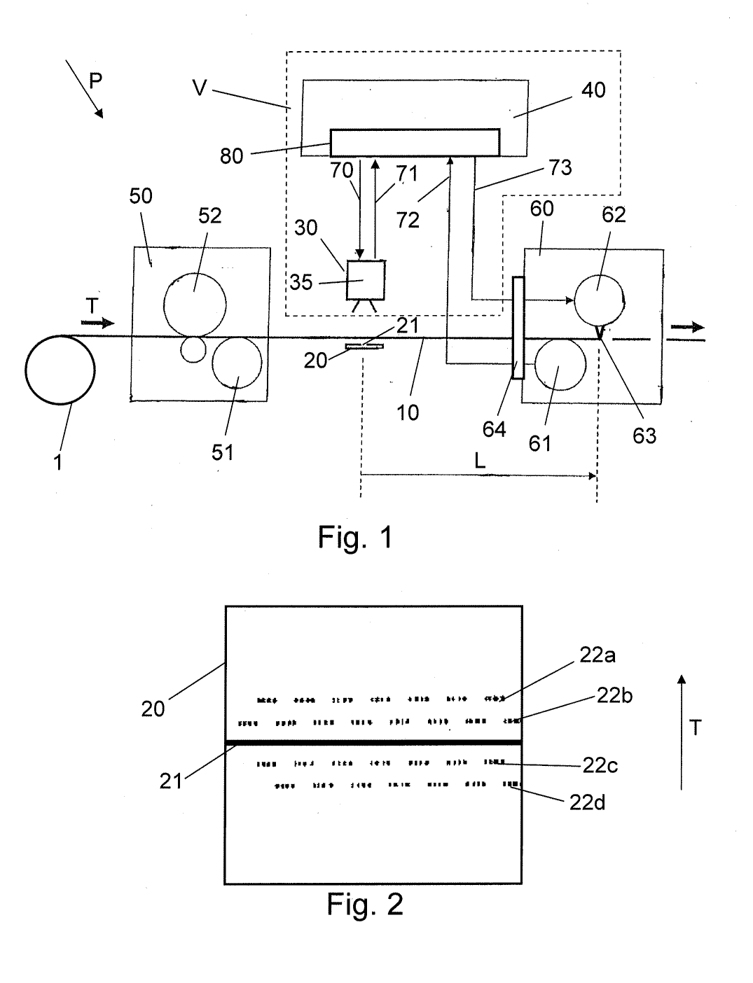

FIG. 1 shows a view from the side of a simplified further processing system P in which an exemplary embodiment of the device V is used. A web 10 comprising a printing substrate is unwound from a reel 1 and is supplied to a printing press 50. The printing press 50 comprises a print unit 52 and a drive 51, for example a first servo unit, for transporting the web 10 in a direction T. The drive 51 essentially determines the speed of the printing substrate which consists of paper for the embodiment described herein. Of course, other printing substrates such as foils, for example, can also be used for web 10.

The printed web 10 which arrives from the printing press 50 is cut into individual printed sheets in a further processing device 60, embodied as a cross cutter. This cross cutter is used only as an example for a further processing device 60, wherein this can also be a different device such as a folding device. The further processing device 60 may comprise a second servo unit 61 which operates jointly with the first servo unit 51 to adjust or maintain the tension of the web 10. Since the position of the second servo unit 61 is known, the position of the web 10 is also known with a specific deviation. The deviation above all results from the non-homogeneity of the web 10 and the slip between the web 10 and drive rollers, not shown herein, of the first and second servo units 51, 61. The processing device 60 furthermore comprises a cutting drum 62 with a blade 63, which is embodied as drum blade for the present example.

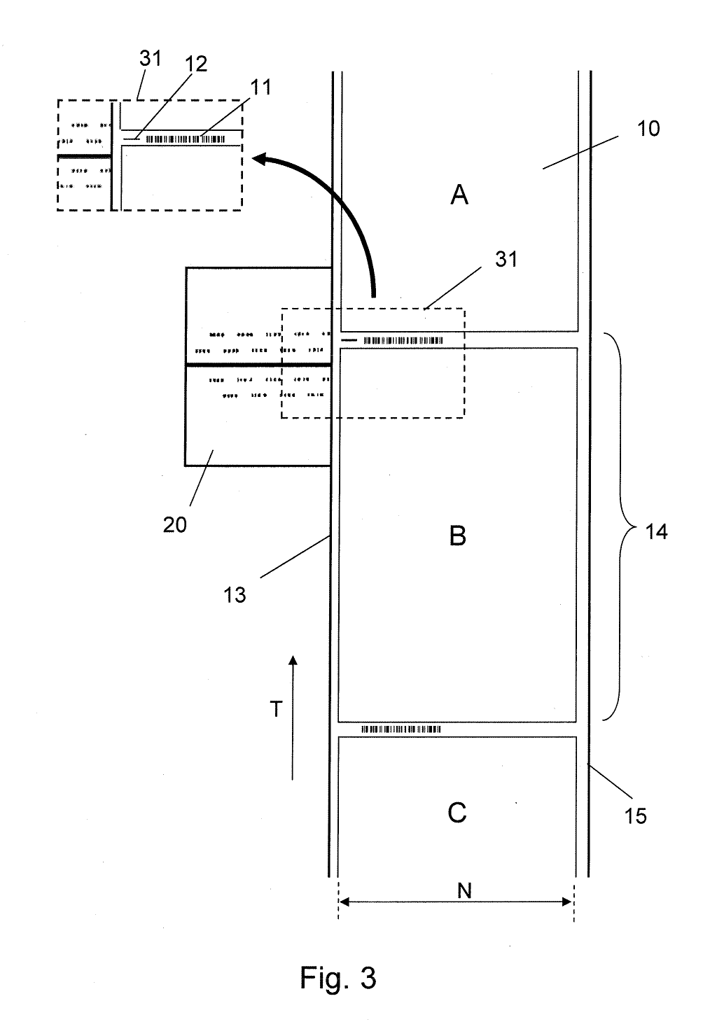

An exemplary embodiment of the device V, embodied according to the invention, is arranged between the printing press 50 and the further processing device 60. Several further processing devices 60, each provided with a separate device V, can also be arranged along the web 10. The device V comprises an image detection system 30, an image processing system 40 and a control unit 80. Furthermore provided is a stationary reference element 20 with machine-readable markings which are essentially arranged parallel to the web 10 and can be embodied either as a reference line or as barcodes. The markings will be explained in further detail in connection with FIG. 2. The machine-readable marking 21, which is embodied as a reference line, and the tip of the blade 63 jointly define a distance L which is advantageously selected as short as possible. The design of the stationary reference element 20 is explained in further detail in connection with FIG. 2 and the function is explained in connection with FIGS. 3, 4 and 5. The control unit 80 is connected via control lines to the image-detection system 30 and the image processing system 40, so as to control these systems, and is advantageously also connected to a control unit 64 of the further processing device 60. The control unit 80 can also be connected to a central system control, which is not shown herein. The advantage of this arrangement is that programming adaptations and/or the input of correction values, of information concerning the printing and of information relating to the affixed print marks etc., can be entered directly at a central control desk for the system. The control unit 80 is connected to the other components via data and control lines which can be embodied as a data bus system. For this example, the image detection system 30 comprises one camera 35, but can also comprise several cameras, wherein this camera 35 in particular may be a matrix camera or a line-type camera. The data bus system comprises a data line 71 for transmitting the camera data and in particular the recorded images to the image processing system 40. Control signals used to trigger the recording of images are transmitted in this case by the control unit 80 via a control line 70 to the camera 35. The control unit 80 transmits the position of a cutting mark to the further processing device 60. Based on this, the further processing device 60, in turn, can be synchronized once more with the cutting drum 62. The control signal for triggering the recording of an image 31 can also come from the further processing device 60, wherein the image processing system in this case does not need to be supplied with position information relating to the web 10 and only needs to transmit the values for the distance L, associated with the corresponding control signal, during a sufficiently short interval to the processing device 60. The data bus system further comprises a control line 73 for adjusting the cutting position and a line 72 for transmitting a position value from the second servo unit 61 to the control unit 80. The lines 70, 71, 72, 73 are designed to transmit the data with the required accuracy. For example, the data line 71 can comprise 16 individual lines for a 16-bit data width, wherein this is known to one skilled in the art and will not be explained further.

FIG. 2 shows an example of a stationary reference element 20 with machine-readable markings 21, 22a-22d which are embodied as a reference line and/or calibration bar. The stationary reference element 20 is preferably a fixedly mounted plate that is arranged as close as possible to the web 10 and substantially parallel thereto. The plate surface facing the web 10 is embodied with a color which offers the highest possible contrast to the color of the printed on markings 22a-22d and/or the marking 21 embodied as reference line. The color of the plate surface preferably is black while the color of the markings 21, 22a-22d is white. Depending on the requirement, it is also possible that only the marking 21 which is embodied as reference line is present or that only the markings 22a-22d are used. The marking 21 in the form of a reference line is arranged approximately in the center of an image 31 that is recorded by the camera 35. The markings 22a-22d only represent an example of a calibration bar that is easy to interpret by the image processing system 40. With this example, the markings 22a-22d are barcodes, in the following called short barcodes, which can have numerical values of 0, 1, 2, . . . 99. The lines for the markings 22a-22d are offset, relative to each other, so that the individual short barcodes are not superimposed. The numbers represented by the short barcode increase from the left to the right and represent the position of their first black/white transition, for example in mm. The geometric variables such as distance between individual markings 22a-22d in a line, the line spacing for the markings 22a-22d, the height of the markings 22a-22d etc. are known to the image processing system 40 or are transmitted to this system. The position of all first black/white transitions of each individual block of short barcodes can be used to increase the precision for detecting the markings 22a-22d, wherein other types of encodings can also be used. The web 10 has two side edges 13 and 15. With the aid of the markings 22a-22d, the position of the edge 13 on the web 10, relative to the stationary reference element 20, can be determined from the image 31. This will be explained further in connection with FIG. 3. Of course, the reference element and the device V can also be arranged such that the position of the edge 15 can be determined. A useful strip of the web 10 is given the reference N. The useful strip N is understood to be a printed-on region on the web 10 which is later visible on the finished printed product. As shown in FIG. 3, the web 10 respectively has a narrow unprinted strip in the region of the edges 13, 15. These two strips do not belong to the useful strip N. The useful strip N can also be arranged such that an unprinted strip is arranged only on one side of the web 10. If the useful strip N has the same width as the web 10, the unprinted strips can be omitted.

FIG. 3 shows a detail of the printed web 10, as seen from the direction of the camera 35. For this example, the stationary reference element 20 is overlapped by the web 10 and is arranged behind the web 10. An overlapping is always ensured for the reliable determination of the edge 13 position. For example, if a narrow web 10 is used, the stationary reference element 20 can be displaced accordingly in the direction transverse to the transporting direction T of the web 10 to ensure the overlapping. Depending on the recording area for the camera 35, the camera can also be displaced transverse to the web 10 in the aforementioned case. The stationary reference element 20 can furthermore also be arranged in front of the web 10, provided it does not cover the print marks 11, 12 that are printed onto the web 10. An image 31 recorded with the camera 35 is shown to the left of the web 10. This image 31 comprises at least a section of the stationary reference element 20 and a sufficiently large region of the web 10 for detecting print marks 11, 12. The control unit 80 shown in FIG. 1 activates the camera 35 so that the web 10 is advantageously imaged continuously over a wide strip of, for example, 10 cm. The instance for transmitting the corresponding control signals is inferred by the second servo unit 61, based on knowledge of the web 10 position. In the process, control signals are transmitted at regular intervals of, for example, a few centimeters to the camera 35. With each control signal, the control unit 80 remembers the actual position of the printing substrate which is achieved with the aid of a query of the further processing device via the line 72. The frequency of the control signals transmitted for the recording of images 31 can also be changed, in particular automatically, during the operation. However, the control signals could also be triggered directly by the further processing device 60. In that case, only the further processing device 60 must store the precise position at which the respective image 31 has been recorded.

FIG. 3 illustrates the situation where the image detection system 30 has recorded an image 31 and the image processing system 40 identifies in the image 31 a coded print mark 11 and an associated, conventional print mark 12 embodied as cutting mark. For the present case, the general designation of a print mark is understood to comprise the coded print mark 11, as well as the conventional print mark 12 in the form of a cutting mark, wherein a different conventional print mark than the cutting mark can also be used. The print mark 11, 12 is advantageously added in a region of the web 10, especially an unprinted region, between two successively following sheets that are printed onto the web, as shown in FIG. 3. Since this region in which the web 10 is later cut into individual sheets always contains a zone of several millimeters of unprinted material, a coded print mark 11 and, if applicable, a corresponding conventional print mark 12 with a known, geometric reference to the remaining print can always be printed on. The coding of the print mark 11 represents a designation which does not otherwise appear in the remaining print image of the useful strip N of the web 10, in particular a one-dimensional or a two-dimensional barcode, for example a data matrix code, by which a printed sheet and/or a printed product can be clearly identified. Particularly suitable is a longer barcode, for example the widely used Code 128 which represents a 12-digit decimal number.

Possible codes for the print mark 11 of a printed sheet and/or a printed product can be transmitted to the image processing system 40 prior to realizing the step of searching for print marks 11, 12 in the image 31.

The position of the print mark 11, 12 is determined from the image 31, with reference to the marking 21 that is embodied as a reference line and/or the edge 13 of the web 10. Based thereon, the image processing system 40 computes an offset value for the print mark 11, 12, relative to the reference line of the stationary reference element 20. The control device 80 adds a value which corresponds to the offset determined for the print mark 11, 12 to the value for the actual position of the printing substrate and transmits the combined value to the further processing device via the control line 73. With the distance L, the further processing device 60 also knows the geometric distance for the web 10 from the image center of the camera 35 to the blade 63. Based on the knowledge of the actual position of the printing substrate, the further processing device 60 can then correct the position of the blade 63, such that this blade cuts through the web 10 precisely at the location of the print mark 12 that is embodied as cutting mark.

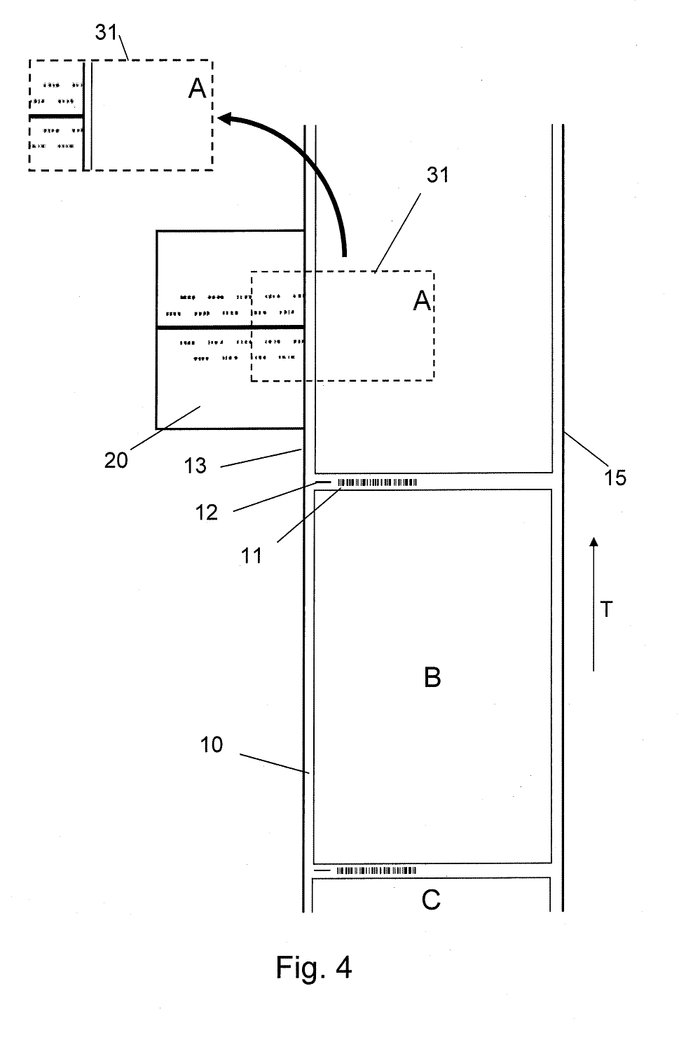

FIG. 4 shows a second situation in which the camera 35 has received a control pulse for recording an image 31 before the coded print mark 11 and/or the conventional print mark 12 has reached the field of vision of the camera 35. The image processing system 40 in that case searches the image 31 unsuccessfully to detect a print mark and then ends the evaluation.

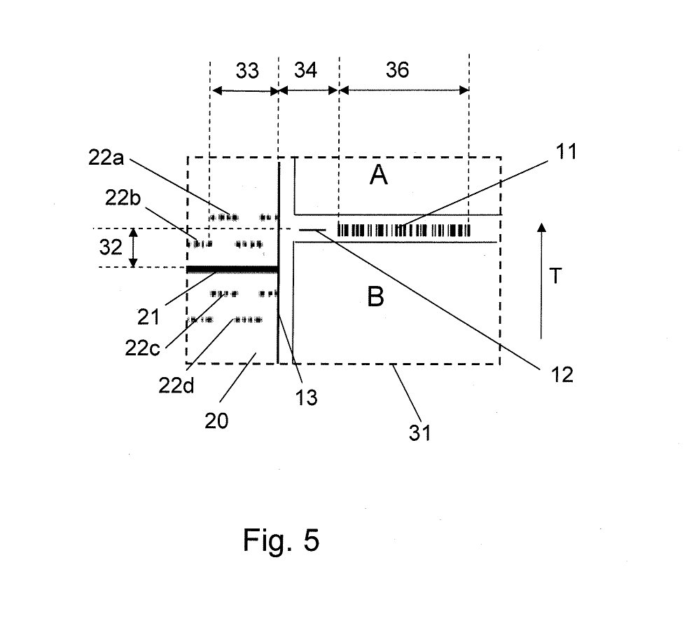

FIG. 5 shows an enlarged version of the image 31 from FIG. 3, which is used in the following to describe in further detail the evaluation of the position detection of the print mark 11, 12. Seen crosswise to the transporting direction T, the absolute position of the web 10 can be determined from the distance 33 between a black/white transition of the marking 22b, embodied herein as short barcode, and the edge 13 of the web 10. To determine the position of the edge 13, the circumstance is used that the printing substrate contains no printing in an area measuring several millimeters around the print marks 11, 12, so that the edge 13 of the web 10 can always be detected relative to the black background of the stationary reference element 20. Based thereon, it also follows that the detection of the edge 13 of the web 10 can furthermore detect a tear in the web 10 since no edge 13 is detected in the image 31. The orientation of the web 10 can be detected from the image 31 through determining an angle between the edge 13 of the web 10 and the reference line for the stationary reference element 20 and to compare this angle to a reference angle, in particular of 90°. The web 10 is not oriented correctly if a deviation is detected and the following processing step presumably cannot be realized precisely. In that case, the control unit 80 generates a warning which can be transmitted, for example, to the central system control. It is furthermore conceivable that the angle deviation is corrected with the aid of actuators.

The distance 34 corresponds to the position of the encoded print mark 11, relative to the edge 13 of the web 10, transverse to the transporting direction T. In the process, the starting position of the barcode is initially determined or, if it is already known, is called up. The absolute position of the barcode follows from the addition of the distances 33 and 34. Since the image processing system 40 has information relating to the type of printed barcode, the position of the detected barcode furthermore allows drawing a conclusion relating to the position of the conventional print mark 12.

In the transport direction T, the distance 32 corresponds to the amount of the offset between the encoded print mark 11 and the marking 21, which is embodied as reference line. The accuracy of determining the offset 32 can be increased by evaluating the position of the cutting mark. If the reference element 20 is covered completely by the web 10 and the reference line is not visible, the center of the image recorded by the camera 35 can be used as reference. The determined distances 32, 33, 34 consequently provide correction values for synchronizing the further processing device 60 and the web 10 in dependence on the position of the print mark 11, 12. The position of the encoded print mark 11 in particular is transmitted to the control unit 80 of the image processing system 40, meaning the offset of the print mark 11, 12 to the side or in longitudinal direction, relative to a reference position or its angle and/or the position relative to the web 10. In that case, the machine-readable markings 21, 22a, 22b, 22c, 22d of the stationary reference element 20 function as a reference position or the position of the camera 35 is used. In order to calibrate the cutting position, the correction values are then transmitted to the control unit 64 for the further processing device 60.

For a different example that is not shown herein, a folding device can be provided as further processing device 60. In that case, the correction value to be transmitted would be a lateral fold position of the sheet printed onto the web 10. This position could follow from the previously explained determination of a cutting mark, in this case a folding mark.

For a different application of the device V, the actual tension of the web 10 can be determined by measuring the variable for a print mark 11, 12.

In the first case, the tension of the web 10 can be computed with the aid of determining the size of a print mark 11, 12, in particular a width 36 of the coded print mark 11 perpendicular to the transporting direction T. Since the width of the web 10 decreases proportional to the tensile stress in the transporting direction, the width 36 of the coded print mark 11 is also shortened with increasing tensile stress.

In the second case, a reference variable taken from the camera 35 calibration bar can be provided, based on the ratio between the actual size of the print mark 11, 12 and the image size of the print mark 11, 12 that is recorded in a reference plane for the web 10. This reference variable can be compared during the operation of the system to a computed calibration bar. If the web 10 sags, the image 31 is smaller than a fictional image located in the reference plane. As a result, the reference variable would not coincide with the computed calibration bar. This difference can be used to compute the deviation in the distance between the camera 35 and the print mark 11, 12, from which furthermore a measure for the tension of the web 10 can be derived. Known algorithms, for example, precisely compute the distances between two parallel edges, right down to a sub-pixel in a printed image.

Furthermore possible is an absolute determination of the tension of the web 10 if the calibration bar which changes and is computed for each image 31 from several successively following and overlapping images 31 is used to determine the oscillation frequency of the paper web.

A coded print mark, which preferably is a barcode and functions as a replacement or to detect conventional print marks, can simultaneously be used for the identification of the printed sheets and can be referred to as an intelligent print mark because of its multiple use options. In other words, the determined correction value obtained according to the invention can be an identification code, assigned to at least one printed sheet, for tracking a product during the course of the following processing steps. In particular, for digital printing, it is important to verify which printed sheet is momentarily located in the further processing device. Particularly useful is a “talking” code for detecting the sheet number of a later printed product to which the coded print mark is assigned and/or for detecting the location at which the later printed product is clearly identified. The control for the printing press advantageously transmits the recently printed-on marks to the control unit 80, thus preventing the barcodes belonging to the product printing or similar, barcode-like symbols from triggering misinformation, owing to the fact that the control unit only accepts the current barcodes. The device V can thus only be used to securely and clearly identify a printed sheet to ensure a precise product tracking and to trigger further actions downstream, which are controlled by the product identification.

In summary, the device V as described herein, which essentially comprises an image processing system 40, a control unit 80 with one or several connected cameras 35 and lines 70, 71, 72 and 73 for the internal data exchange and the data exchange with external the units 61, 62, is capable of searching for coded print marks 11, 12 on a web 10 that is moving past. A control signal, emitted each time the web 10 advances a few centimeters, triggers the recording of an image 31 on the web 10. At the same time, the momentary position of the servo units 51, 61 is stored, for example by the control unit 64 of the cross cutter and, if applicable, by the control unit 80 of the image processing system 40. The image processing system 40 detects whether or not a coded print mark 11, 12 is present on the image 31. If such a print mark is detected, the precise position of the coded print mark 11 or the associated conventional print mark 12 is determined. Furthermore determined is the position of the marking 21 of the reference element 20, which is embodied as reference line and is advantageously positioned approximately in the image center. The information relating to the position of the print mark 11, 12 and/or an identification of a printed sheet belonging to the print mark is then transmitted to the further processing device 60 that may be embodied as cross cutter for realizing a subsequent processing step.

A further advantage of the device V is that by using a stationary reference element 20, which can be a component of the device V, the calibration of the camera can be omitted or at least a fully automatic calibration can take place if no printing substrate is present. If the stationary reference element 20 is visible, then smaller mechanical changes to the camera position, caused by vibrations, heat deformations and the like, do not influence the measurement or only to a negligible degree. Each image recording in turn permits a new calibration of important parameters which are described by the camera position and its imaging characteristics. For example, when evaluating an image 31, it is possible to determine a deviation, visible in the image 31, of the position of the marking 21 that is embodied as reference line from the image center of image detection system 30. As a result, the camera 35 can be replaced without recalibration and smaller, mechanical changes can be compensated by determining the parameters anew.

Since the print marks no longer need to be positioned on an unprinted strip, the position of the print marks, at least in the direction crosswise to the web 10, can be selected to be the most favorable position with respect to the process, e.g. in the center of the sheet. This is particularly advantageous, for example, when using several partial web sections to ensure the position-correct guidance of web sections one above the other one, so as to form a composite configuration of web sections. If several partial webs 10 are guided parallel to each other, then the offset 32 of the coded print mark 11 in the transporting direction T for each partial web, the distance 33 of a calibration bar marking 22a-d from the edge 13, as well as the distance 34 of the position of the coded print mark 11 from the edge 13 can be determined and the position of the partial webs can be synchronized with the aid of actuators.

A further advantage is the savings in the number of sensors since only one sensor, e.g. a matrix camera, is needed to measure the aforementioned variables in place of using different sensors for each measuring variable (cutting mark position, measuring of web edges, sheet identification and the position relative to the web).

The barcode used in the Figures is only intended as example for a coded print mark 11. Other symbols that will not appear in the useful strip N can also be used as coded print marks.

The further processing of the web 10 following the synchronizing is based on the correction value determined according to the method of the invention. In the process, coded print marks can be used not only by cross cutters, as described in the exemplary embodiment, but by each additional processing device for which the operation can be synchronized with the aid of coded print marks, such as the stamping and/or labeling and/or inscribing and/or perforating and/or folding and/or cutting operations on or at the web. As explained for the exemplary embodiment, the web can be printed with the aid of a printing press, arranged upstream of the further processing device, wherein it is also possible to feed a pre-printed web directly from the reel to the further processing device.

Even though advantageous embodiments of the invention have been shown and described herein, the invention is not limited to these but can be embodied and used differently within the framework of the following claims.

What is claimed is:

1. A method for processing a web of a printing substrate to form printed products, comprising:
a) affixing at least one print mark assigned to a printed sheet of the web to a useful strip of the web, wherein the print mark includes a coded print mark;
b) recording at least one image which shows a region of the web in which the at least one affixed print mark is located;
c) searching for and identifying the at least one print mark in the at least one recorded image;
d) determining a position of the print mark in the at least one recorded image and, based on the determined position, inferring the position of the print mark on the web; and
e) determining at least one correction value for synchronizing a subsequent further processing of the web in dependence on the position of the print mark on the web.

2. The method according to claim 1, wherein the step a) includes affixing the at least one print mark to an unprinted section between two successively following printed sheets on the web.

3. The method according to claim 1, including determining a position of one edge of the web relative to a stationary reference element from the at least one image, wherein the stationary reference element comprises machine-readable markings.

4. The method according to claim 3, wherein the step d) includes determining from the at least one image the position of the print mark on the web relative to one of the stationary reference element or the edge of the web.

5. The method according to claim 3, further including determining an orientation of the web from the image by determining an angle between the edge of the web and the machine-readable markings of the stationary reference element, and comparing the angle to a reference angle.

6. The method according to claim 1, wherein the coding of the print mark affixed in step a) corresponds to a designation by which at least one of a printed sheet, signature and printed product is identified.

7. The method according to claim 1, wherein the coding of the print mark affixed in step a) comprises one of a one-dimensional or a two-dimensional barcode.

8. The method according to claim 1, further including, prior to the step c), transmitting the coding of the print mark on a printed sheet or a printed product to an image processing system.

9. The method according to claim 1, wherein the print mark further includes a cutting mark.

10. The method according to claim 1, wherein the correction value characterizes the position of the print mark on the web relative to a reference position.

11. The method according to claim 1, wherein the correction value characterizes the position designated for the further processing of a printed sheet on the web.

12. The method according to claim 1, including issuing control signals for recording of the images, wherein the control signals have a frequency that is adapted automatically during operation.

13. The method according to claim 1, including determining an actual tension of the web by measuring a variable for the coded print mark.

14. The method according to claim 1, including using the the coded print mark as an identification code that is assigned to at least one printed sheet and functions to track the product during a course of the further processing.

15. The method according to claim 1, further including subjecting the web to further processing following the synchronizing based on the correction value obtained during step e).

16. A device for processing a web of a printing substrate to form printed products, the device comprising:
an image-recording system adapted to be focused onto a printed side of a web for recording an image of a region of the web in which at least one coded print mark is located;
an image-processing system coupled to receive an output from the image-recording system to evaluate the at least one image, including: searching for and identifying the at least one print mark in the at least one recorded image; determining a position of the print mark in the at least one recorded image and, based on the determined position, inferring the position of the print mark on the web; and determining at least one correction value for synchronizing a subsequent further processing of the web in dependence on the position of the print mark on the web; and
a control unit operative to control the image-recording system and the image-processing system.

17. The device according to claim 16, further including a stationary reference element arranged either in front of or behind the web and overlapping with the web, which reference element comprises machine-readable markings are arranged substantially parallel to the web.

18. The device according to claim 16, wherein the image-recording system comprises at least one camera.

19. The device according to claim 16, wherein the at least one camera comprises a matrix camera.
